(19) United States
(12) Patent Application Publication
(10) Pub. No.: US 2008/0298817 A1
(43) Pub. Date: Dec. 4, 2008

(54) Light Receiving Device

(75) Inventor: Toshihisa Matsuo, Nara (JP)

Correspondence Address: EDWARDS ANGELL PALMER & DODGE LLP, P.O. BOX 55874, BOSTON, MA, 02205, US

(73) Assignee: Sharp Kabushiki Kaisha, Osaka (JP)

(21) Appl. No.: 11/658,329

(22) PCT Filed: Jul. 6, 2005
(86) PCT No.: PCT/JP2005/012480

§ 371 Date: Jan. 23, 2007

(30) Foreign Application Priority Data
Jul. 26, 2004 (JP) 2004-217095

(51) Int. Cl. H04B 10/06

(52) U.S. Cl. 398/212; 250/216

(57) ABSTRACT

A light receiving device includes a frame 1, and a light-receiving element 2 placed on one surface side of the frame 1. The other surface of the light-receiving element 2 opposite to the frame 1 side, as well as the frame 1, are grounded. Thus, the GND potential is present on the one surface side of the light-receiving element 2, while the other surface of the light-receiving element 2 is also of the GND potential. Consequently, there is provided a light receiving device being small-sized and having an effective noise shielding effect as well as high heat radiation property.

### TECHNICAL FIELD

The present invention relates to a light receiving device to be used for, for example, optical communications.

### BACKGROUND OF THE INVENTION

In recent years, optical communications have been being used more and more as information transmission means along with increasing capacities of information and higher communication speeds. Optical communications, while currently used as a high-speed communications means in communications trunk lines, are partly incorporated also into domestic inter-equipment communications under the progress of home information. For the future, it is predicted that optical communications will be used for wider applications directed toward communications and networking in in-home, in-vehicle or other novel fields by virtue of their high-speed and high-reliability characteristics. In particular, by virtue of their disturbance- and noise-proof property or low-and-unwanted radiation noise-proof property, optical communications have been got into the limelight as an in-vehicle inter-equipment communications means, and some vehicles have already been equipped with optical communications as an example. The optical communications are expected to grow in that field in the future.

Implementation of optical communications involves optical fibers as a communications medium and transmitter-receivers to perform optical transmission and reception. The transmitter is a device for converting a communication signal to an optical signal and sending it out to the optical fiber. A light source for the conversion into the optical signal is commonly given by a light emitting diode (LED) or semiconductor laser (LD). Driving these light sources for modulation in response to a communication signal allows an optical signal to be obtained.

The light receiving device is a device for receiving an optical signal emitted from the transmitter via an optical fiber. The light receiving device contains light-receiving elements for conversion of an optical signal into an electrical signal. The light-receiving elements are commonly given by a semiconductor device called photodiode. This is a device having a characteristic that as light of a wavelength falling within its photosensitivity range has been incident on its light-receiving portion, there flows an electric current called photocurrent responsive to an incident light intensity. The photocurrent, which is an output from the photodiode, is often subjected to a current-to-voltage conversion process, being treated as a voltage signal.

An output of the light-receiving element, which is a weak signal, needs to be amplified later by an amplification part having a high amplification factor. The part is therefore a part highly susceptible to noise. Conventional countermeasures therefor, generally, include i) placing the noise source and the light-receiving portion away from each other, and ii) covering the light-receiving portion with a conductive shield member.

Whereas there is a great expectation for use of optical communications in vehicles as a future application field as described above, the device used in such a case is required to have high degree of reliability. As to the working temperature, it is impermissible to presume the use of the device at temperatures around room temperature as it would be for general equipment, and the use under a wide range of working environmental temperatures is required. In particular, high-temperature side operations are required, so that a device capable of ensuring stable operations under high temperatures and having a high heat radiation property is necessitated.

Meanwhile, because of a requirement for size reduction of the device as on-vehicle equipment, there is a need for meeting contradictory requirements of achieving the size reduction while ensuring noise shielding and high heat radiation.

As a solution to these, in a light receiving device disclosed in JP 11-131283 A, the light-pervious sealing resin except the light-receiving portion is Ni-plated. In a light receiving device disclosed in JP 2001-36100 A, in which a light-receiving element is mounted on a flexible board, only the surface in the direction of incidence in the light-receiving element is noise-shielded with a grounding pad.

However, those conventional light receiving devices have had the following problems.

That is, in the light receiving device having the countermeasure shown at item i), there is a difficulty in reducing the size of the light receiving device in order to ensure the distance from the noise source. In the light receiving device having the countermeasure shown at item ii), there is a drawback that adding the shielding member incurs an increase of cost, an increase of assembly steps and a difficulty in size reduction.

Further, in the light receiving device disclosed in JP 11-131283 A, whereas the light-pervious sealing resin except the light-receiving portion is Ni-plated, a manufacturing step therefor is necessarily added, with intermediate members such as masking tape or the like also involved. This addition of the step further causes a fear that the product yield may decrease, and due to those factors, increases in production cost are unavoidable. Besides, as to the heat radiation, whereas the light-pervious sealing resin is interposed between the heat generation source (light-receiving element) and the Ni-plated portion, a light-pervious sealing resin is generally poor in heat conduction, so that the resulting heat-radiation improvement effect can not be successful.

In the light receiving device disclosed in JP 2001-36100 A, only the surface in the direction of incidence is shielded in the light-receiving element, so that no effect is produced against noise intrusion in other directions. Besides, the flexible board is not so good in heat conduction, with the results of poor heat radiation as well as a fear for shifts in the receiving optical axis due to deformation of the board under high temperatures.

### SUMMARY OF THE INVENTION

Accordingly, an object of the present invention is to provide a light receiving device which has an effective noise shielding effect, having a high heat radiation characteristic, and yet capable of fulfilling a size reduction.

In order to achieve the above object, according to the present invention, there is provided a light receiving device comprising:

an electrically conductive frame having an opening;

an electrically insulative board placed on one surface of the frame and in proximity to the opening of the frame; and

a light-receiving element which has a light-receiving portion and which is placed on one surface of the board opposite to its one side on which the frame is placed in such a manner that the light-receiving portion overlaps with the opening of the frame, wherein

one surface of the light-receiving element opposite to its light-receiving portion side, as well as the frame, are grounded or connected to a power supply potential.

Herein, the light-receiving portion refers to a portion that actually responds to light in the light-receiving element, and the one surface of the light-receiving element on the light-reception side refers to its light-receiving surface.

In the light receiving device of this invention, since the other surface of the light-receiving element opposite to its light-receiving portion side one surface, as well as the frame, are grounded or connected to the power supply potential, the GND potential (of the frame) or the power supply voltage is present on the one surface side of the light-receiving element while the other surface of the light-receiving element is of the GND potential or power supply potential. Thus, the light-receiving portion of the light-receiving element or the like is sandwiched by the GND potential or power supply potential, so that a shielding structure of the GND potential or power supply potential is formed against the light-receiving element. As a result, a noise shielding effect for a light reception circuit of the light-receiving element can be obtained.

Since the frame serves also for the role of generating the GND potential or power supply potential on the one surface side of the light-receiving element, there is no need for any additional member for producing the noise shielding effect. Thus, a size reduction of the device can be achieved.

Further, the frame is capable of effectively radiating heat generated in the light-receiving element.

Consequently, a light receiving device having an effective noise shielding effect as well as high heat radiation property and capable of size reduction can be realized.

In one embodiment, the board has light permeability.

In the light receiving device of this embodiment, since the board has light permeability, light can reliably be received by the light-receiving element while the device strength can be improved.

In one embodiment, the board has an opening at a position where the opening overlaps with a light-receiving portion of the light-receiving element.

In the light receiving device of this embodiment, since the board has the opening, the material for the board may be given by selecting one having a better thermal conductivity than light-pervious materials, allowing the heat radiation property to be improved.

In one embodiment, the opening of the frame, an opening of the board and the light-receiving portion of the light-receiving element are placed so as to be generally coaxial with one another.

In the light receiving device of this embodiment, since the opening of the frame, the opening of the board and the light-receiving portion of the light-receiving element are placed so as to be generally coaxial with one another, an efficient incidence of light to the light-receiving portion can be fulfilled in terms of incident light quantity, so that the light-reception efficiency of the light-receiving portion can be improved.

In one embodiment, a coefficient of linear expansion of the board is a value between a coefficient of linear expansion of the frame and a coefficient of linear expansion of the light-receiving element.

In the light receiving device of this embodiment, since the coefficient of linear expansion of the board is the value between the coefficient of linear expansion of the frame and the coefficient of linear expansion of the light-receiving element, the board has a function as a cushioning material against thermal stress by the frame and the light-receiving element due to thermal changes, allowing the working temperature range to be extended.

In one embodiment, the coefficient of linear expansion of the board is a value closer to the coefficient of linear expansion of the light-receiving element than to the coefficient of linear expansion of the frame.

In the light receiving device of this embodiment, since the coefficient of linear expansion of the board is the value closer to the coefficient of linear expansion of the light-receiving element than to the coefficient of linear expansion of the frame, the thermal stress applied to the light-receiving element can be lessened so that damage of the light-receiving element can be prevented.

In one embodiment, the frame has a recessed portion on the one surface of the frame and around the opening of the frame, and

the board is placed within the recessed portion of the frame.

In the light receiving device of this embodiment, since the board is placed within the recessed portion of the frame, the distance between the frame (a site having GND potential or power supply potential) and the other surface of the light-receiving element (a site having GND potential or power supply potential) is further shortened, so that the noise shielding effect can be enhanced.

In one embodiment, a depth size of the recessed portion of the frame is larger than a thickness size of the board.

In the light receiving device of this embodiment, since the depth size of the recessed portion of the frame is larger than the thickness size of the board, influence of the board against the shielding hermeticity can be suppressed to a minimum.

### BRIEF DESCRIPTION OF THE DRAWINGS

FIG. 1A is a partly sectional side view showing a first embodiment of a light receiving device of the present invention;

FIG. 1B is a plan view of the light receiving device of the invention;

FIG. 1C is a plan view of a board;

FIG. 1D is a bottom view of a light-receiving element;

FIG. 2 is a partly sectional side view showing a second embodiment of a light receiving device of the present invention;

FIG. 3 is a partly sectional side view showing a third embodiment of a light receiving device of the present invention.

### DETAILED DESCRIPTION OF THE INVENTION

Hereinbelow, the present invention will be described in detail by way of embodiments thereof illustrated in the accompanying drawings.

### First Embodiment

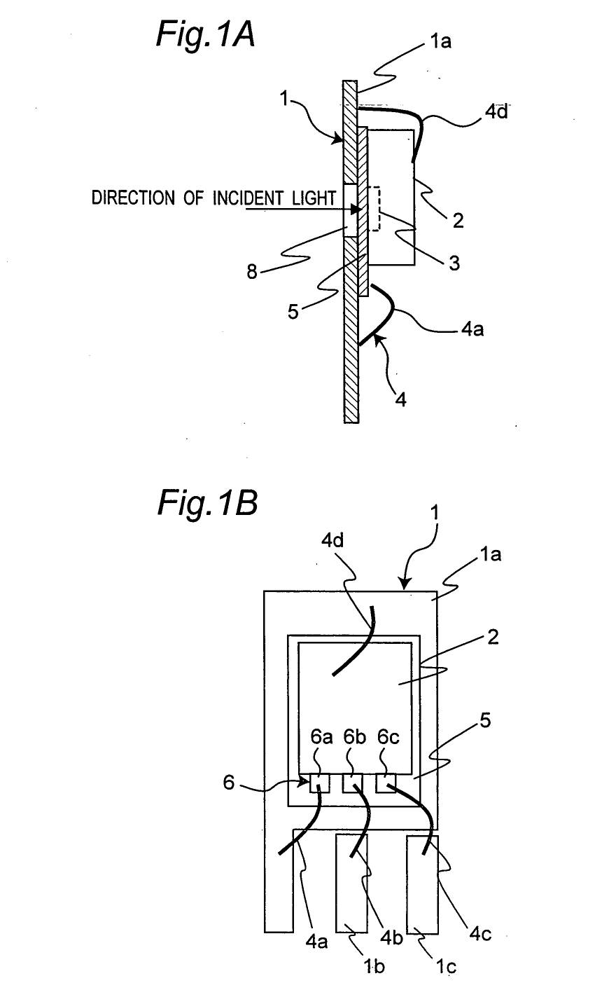

FIG. 1A shows a partly sectional side view of one embodiment of the light receiving device of the present invention. FIG. 1B shows a plan view of the light receiving device of the invention. The light receiving device includes an electrically conductive frame 1 having an opening 8, an electrically insulative board 5 placed on one surface of the frame 1 and in proximity to the opening 8 of the frame 1, a light-receiving element 2 having a light-receiving portion 3 and placed on one surface of the board 5 opposite to the frame 1 side so that the light-receiving portion 3 overlaps with the opening 8 of the frame 1.

The frame 1, which is made of an electrically conductive material such as metal, includes a GND frame 1a to be grounded, a light-reception output frame 1b connected to a light-reception output, and a power supply frame 1c connected to a power supply voltage. The opening 8 is provided in the GND frame 1a, so that light derived from an unshown optical transmitter as an example can be passed through the opening 8.

The board 5, which is made of an electrically insulative material, is placed on one surface of the GND frame 1a opposite to a surface receiving incident light coming along a direction (shown by arrow).

The light-receiving element 2 is placed on one surface of the board 5 opposite to a surface of the board 5 receiving incident light coming along the incident direction (shown by the arrow). Then, at least part of the light that has passed through the opening 8 of the frame 1 passes through the board 5, being received by the light-receiving element 2. That is, the board 5 has light permeability and is, for example, a glass board.

The light-receiving element 2 receives at least part of incident light that has passed through the opening 8. The light-receiving element 2 is given by using, for example, semiconductor such as photodiode or the like. The light-receiving portion 3 of the light-receiving element 2 is a portion that actually responds to light in the light-receiving element 2.

The configuration of the opening 8 of the frame 1, which is not particularly limited, has only to allow light to pass to the light-receiving portion 3 of the light-receiving element 2. Accordingly, the light-receiving portion 3 is so placed as to be able to receive at least part of light that passes through the opening 8. In addition, in consideration of light-reception efficiency of the light-receiving portion 3, the opening 8 of the frame 1 and the light-receiving portion 3 of the light-receiving element 2 are preferably placed so as to be generally coaxial with each other.

Next, an example of the method for mounting the frame 1, the board 5 and the light-receiving element 2 is explained with reference to FIGS. 1A to 1D.

Although an optical semiconductor such as photodiode may be used as the light-receiving element 2, yet it has been practiced in recent years to use ICs (Integrated Circuits) in which a photodiode and peripheral circuits such as a photodiode output amplifier are integrated together for convenience.

In this embodiment, an optical semiconductor IC is used as the light-receiving element 2. FIG. 1D shows a bottom view of the light-receiving element 2 as viewed from the light-receiving portion 3 side (light-receiving surface side). The light-receiving element 2 has an electrode (pad) 7 for signals on the same surface as the light-receiving surface. This electrode 7 includes a GND electrode 7a, an output signal electrode 7b and a power supply electrode 7c. The other surface (rear surface) of the light-receiving element 2 opposite to the light-receiving portion 3 side surface is provided as a GND potential one. Although the rear surface of the light-receiving element 2 (IC) is normally of GND potential, yet there are cases where it is of power supply voltage. In such a case, the frame 1 is set also to the power supply voltage.

FIG. 1C is a plan view of the board 5 as viewed from its one surface side. In order that a signal derived from the electrode 7 of the light-receiving element 2 can be extracted with the light-receiving element 2 mounted on the board 5, a conductive pattern 6 is placed on the light-receiving element 2 side surface (one surface) of the board 5. This pattern 6 includes a GND pattern 6a, an output signal pattern 6b and a power supply pattern 6c.

Then, as shown in FIGS. 1A and 1B, the light-receiving element 2, the board 5 and the frame 1 are assembled one on another, the conductive pattern 6 of the board 5 and the frame 1 are electrically connected to each other by wires 4. The wires 4 include a first wire 4a, a second wire 4b, a third wire 4c and a fourth wire 4d.

That is, as shown in FIGS. 1A to 1D, the GND electrode 7a of the light-receiving element 2, the GND pattern 6a of the board 5 and the GND frame 1a are electrically connected to one another via the first wire 4a.

The output signal electrode 7b of the light-receiving element 2, the output signal pattern 6b of the board 5 and the light-reception output frame 1b are electrically connected to one another via the second wire 4b.

The power supply electrode 7c of the light-receiving element 2, the power supply pattern 6c of the board 5 and the power supply frame 1c are electrically connected to one another via the third wire 4c.

The other surface (rear surface) of the light-receiving element 2 and the GND frame 1a are electrically connected to one another via the fourth wire 4d. In addition, the fourth wire 4d, which is intended to set the rear surface of the light-receiving element 2 to GND potential, may be omitted on condition that the rear surface of the light-receiving element 2 can be set to GND potential by the first wire 4a.

According to the light receiving device of the above construction, since the other surface (rear surface) of the light-receiving element 2 as well as the GND frame la are grounded, the GND frame 1a having the GND potential is placed on the one surface (front surface) of the light-receiving element 2. Moreover, the rear surface of the light-receiving element 2 is also set to GND potential. Therefore, the light-receiving portion 3 and circuit portion of the light-receiving element 2 are just sandwiched by the GND potential. As a result, a noise shielding effect can be obtained.

However, too large a thickness of the board 5 means an increase of the shielding clearance, and therefore the board 5 is preferably set thin in thickness. Nevertheless, since an extremely thin thickness of the board 5 could cause deformation or damage of the board 5 due to thermal stress under high temperatures, the board 5 should be set to a proper thickness.

As to the material of the board 5, if a value of the coefficient of linear expansion of the board 5 is chosen so as to be one between the coefficient of linear expansion of the frame 1 and the coefficient of linear expansion of the light-receiving element 2, then the board 5 can be given a function as a cushioning material against thermal stress by the frame 1 and the light-receiving element 2 due to thermal changes, allowing the working temperature range to be extended. For example, given Cu as the main material of the frame 1, glass as the main material of the board 5 and Si as the main material of the light-receiving element 2, the coefficient of linear expansion of the frame 1 results in 17 ppm/k, the coefficient of linear expansion of the board 5 results in 7.7 ppm/k, and the coefficient of linear expansion of the light-receiving element 2 results in 2.8 ppm/k, thus satisfying the above condition.

More desirably, the material of the board 5 is given by selecting such a material that the value of the coefficient of linear expansion of the board 5 becomes closer to the coefficient of linear expansion of the light-receiving element 2 than to the coefficient of linear expansion of the frame 1, because the thermal stress applied to the light-receiving element 2 can be lessened in this case. The reason of this is that out of thermal stress applied to the frame 1 and thermal stress applied to the light-receiving element 2, the thermal stress that could cause damage of the light-receiving element 2 should preferentially be prevented.

Heat generated in the light-receiving element 2 flows principally to the GND frame 1a via the board 5. From the GND frame 1a, heat further flows to around the GND frame 1a as well as to a master board (not shown) on which this light receiving device is to be mounted. Thus, an effective heat radiation can be accomplished.

In addition, the higher the thermal conductivity of the material of the board 5 used is, the more the heat radiation effect is improved. In this embodiment, glass is used for the board 5, and glass as an electrically insulative material has a good thermal conductivity. Also, the larger the surface area and the thickness (normally, about 0.25 to 0.5 mm) of the frame 1 are, the more the thermal conductivity of the frame 1 can be increased, allowing the heat radiation property to be further improved.

### Second Embodiment

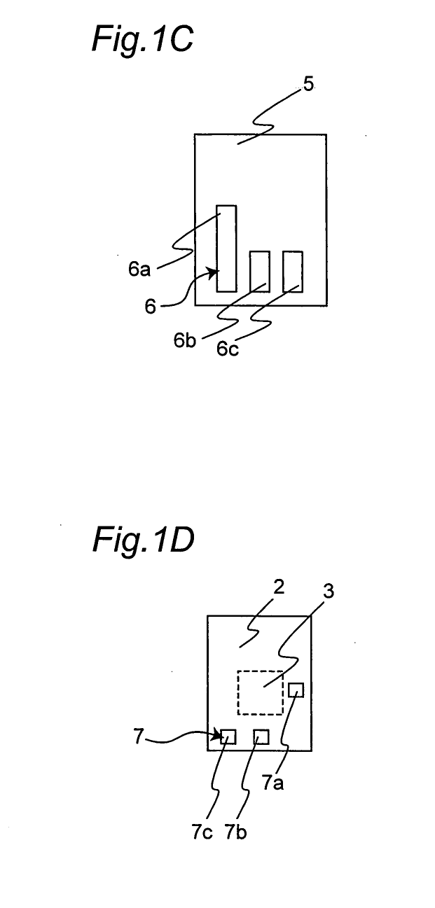

FIG. 2 shows a second embodiment of the light receiving device of the invention. This embodiment differs from the foregoing first embodiment in that a board 5 has an opening 9 at a position where the opening 9 overlaps with the light-receiving portion 3 of the light-receiving element 2. The opening position and configuration of the opening 9 of the board 5 have only to allow at least part of incident light coming through the opening 8 of the frame 1 to pass through.

Thus, since the board 5 has the opening 9, the material for the board 5 may be given by selecting one having a better thermal conductivity than light-pervious materials, allowing the heat radiation property to be improved.

Furthermore, the opening 8 of the frame 1, the opening 9 of the board 5 and the light-receiving portion 3 of the light-receiving element 2 are preferably placed so as to be generally coaxial with one another. In this case, an efficient incidence of light to the light-receiving portion 3 can be fulfilled in terms of incident light quantity, so that the light-reception efficiency of the light-receiving portion 3 can be improved.

### Third Embodiment

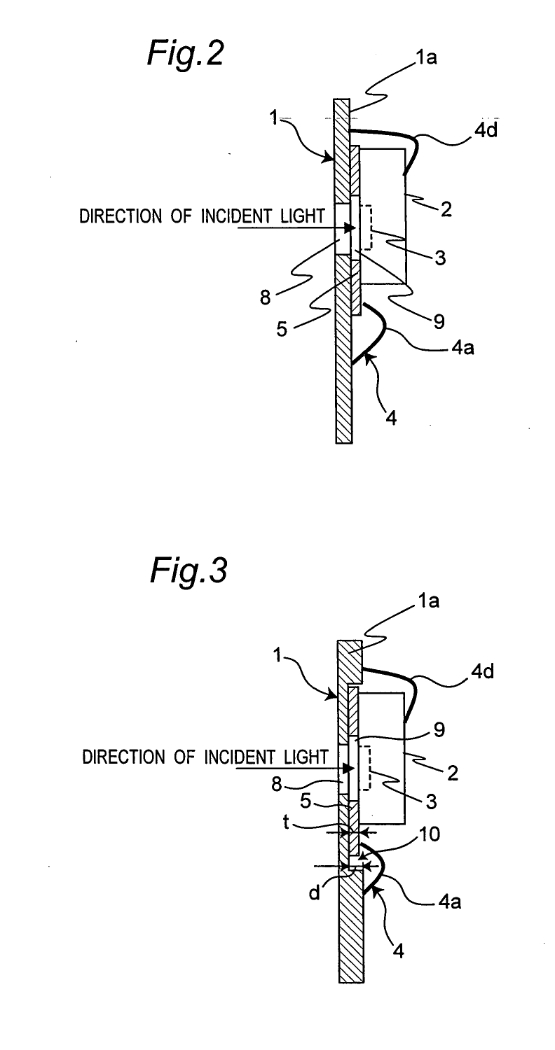

FIG. 3 shows a third embodiment of the light receiving device of the invention. This embodiment differs from the second embodiment in that a frame 1 has a recessed portion 10 around the opening 8 of the frame 1 on one surface of the frame 1 while the board 5 is placed within the recessed portion 10 of the frame 1. That is, the position where the recessed portion 10 is formed roughly corresponds to the mounting position of the board 5.

Thus, since the board 5 is placed within the recessed portion 10 of the frame 1, the distance between the frame 1 (a site having GND potential) and the other surface of the light-receiving element 2 (a site having GND potential) is further shortened, so that the noise shielding effect can be enhanced.

Preferably, the recessed portion 10 of the frame 1 has a depth size ‘d’ larger than a thickness size ‘t’ of the board 5. In this case, effects of the board 5 on the shielding hermeticity can be suppressed to a minimum.

In this embodiment, although the board 5 having the opening 9 is used, such a board 5 having light permeability as shown in the first embodiment may also be used.

In addition, the present invention is not limited to the embodiments described above. For example, the other surface (rear surface) of the light-receiving element 2 as well as the GND frame 1a, other than being grounded, may be connected to the power supply potential (the potential of the power supply voltage of the light-receiving element 2), where the noise shielding effect can be expected if the potential is stable.

1. A light receiving device comprising:
an electrically conductive frame having an opening;
an electrically insulative board placed on one surface of the frame and in proximity to the opening of the frame; and
a light-receiving element which has a light-receiving portion and which is placed on one surface of the board opposite to its one side on which the frame is placed in such a manner that the light-receiving portion overlaps with the opening of the frame, wherein
one surface of the light-receiving element opposite to its light-receiving portion side, as well as the frame, are grounded or connected to a power supply potential,
the frame has a recessed portion formed on the one surface of the frame around the opening of the frame, and
the board is placed within the recessed portion of the frame.

2. The light receiving device as claimed in claim 1, wherein
the board has light permeability.

3. The light receiving device as claimed in claim 1, wherein
the board has an opening at a position where the opening overlaps with a light-receiving portion of the light-receiving element.

4. The light receiving device as claimed in claim 3, wherein
the opening of the frame, an opening of the board and the light-receiving portion of the light-receiving element are placed so as to be generally coaxial with one another.

5. The light receiving device as claimed in claim 1, wherein
a coefficient of linear expansion of the board is a value between a coefficient of linear expansion of the frame and a coefficient of linear expansion of the light-receiving element.

6. The light receiving device as claimed in claim 5, wherein
the coefficient of linear expansion of the board is a value closer to the coefficient of linear expansion of the light-receiving element than to the coefficient of linear expansion of the frame.

7. (canceled)

8. The light receiving device as claimed in claim 1, wherein
a depth size of the recessed portion of the frame is larger than a thickness size of the board.
